(19) United States
(12) Patent Application Publication
(10) Pub. No.: US 2025/0011209 A1
(43) Pub. Date: Jan. 9, 2025

(54) Method and Device for Treating Coking Wastewater through Denitrification and Anammox

(71) Applicant: Tongji University, Shanghai (CN)

(72) Inventors: Huaqiang CHU, Shanghai (CN); Fan WANG, Shanghai (CN); Yalei ZHANG, Shanghai (CN); Xuefei ZHOU, Shanghai (CN); Pei DING, Shanghai (CN)

(73) Assignee: Tongji University, Shanghai (CN)

(21) Appl. No.: 18/613,179

(22) Filed: Mar. 22, 2024

(30) Foreign Application Priority Data
Jul. 4, 2023 (CN) 202310807763.6

(51) Int. Cl. C02F 3/30; C02F 101/16

(52) U.S. Cl. CPC C02F 3/307; C02F 3/305; C02F 2101/16; C02F 2209/02; C02F 2209/06; C02F 2209/16; C02F 2209/22; C02F 2209/44

(57) ABSTRACT

Method and device for treating coking wastewater through denitrification and anammox are provided. The device includes an anaerobic reactor, an anoxic reactor, a sedimentation tank, and an aerobic reactor sequentially communicated, and a coking wastewater tank communicated with the anaerobic reactor through an influent pump. The present disclosure promotes the formation of microgranular sludge in the device through a composite powder carrier, and promotes sulfur-based autotrophic denitrification in anaerobic and anoxic zones through pyrite in the composite powder carrier and an additional sulfur source, and promotes anammox in the anaerobic zone through NO₂⁻—N produced by sulfur-based autotrophic denitrification in the anoxic zone. The present disclosure forms a dual-sludge system through the sedimentation tank to reduce reducing inorganic sulfur-containing substances that compete with nitrifying bacteria, and achieves nitrification in the aerobic zone while oxidizing ionic reducing inorganic sulfur-containing substances. The present disclosure discharges treated wastewater through a membrane component.

### CROSS REFERENCE TO THE RELATED APPLICATIONS

This application is based upon and claims priority to Chinese Patent Application No. 202310807763.6, filed on Jul. 4, 2023, the entire contents of which are incorporated herein by reference.

### TECHNICAL FIELD

The present disclosure relates to the technical field of coking wastewater treatment, and in particular to a method and device for treating coking wastewater through denitrification and anammox.

### BACKGROUND

Coking wastewater is industrial wastewater generated during the high-temperature carbonization of raw coal, the gas purification, and the recovery and refining of chemical by-products. Coking wastewater has a complex composition, including dozens of high-concentration pollutants such as phenols, pyridines, indoles, quinolines, cyanides, thiocyanides, and ammonia nitrogen. Therefore, coking wastewater has high toxicity, poor biodegradability, and very stable property, making it a typical type of degradation-resistant organic wastewater. Coking wastewater is rich in nitrogen (N) and lacking of phosphorus (P), and its treatment process features high energy consumption, high material consumption, and high carbon (C) emission, but signifies great potential for energy conservation and emission reduction. However, the direction of energy conservation and emission reduction transformation in the entire coking wastewater treatment industry is not quite clear. In order to meet effluent quality standards, the coking wastewater treatment process mainly adopts a multi-stage and multi-group combination technique, including pretreatment, anaerobic treatment, aerobic treatment, and deep treatment. The technical principles of coking wastewater treatment mainly rely on traditional nitrification and denitrification, which have problems such as a large carbon footprint, high power consumption for aeration, high sludge yield, and a serious waste of N, sulfur (S), and organic matter recyclable resources.

Anammox is one of the green, sustainable denitrification processes. Compared with traditional nitrification and denitrification processes, anammox reduces theoretical power consumption by 60%, carbon footprint by 90%, and sludge yield by at least 50%. Anammox solves the technical difficulties of wastewater treatment through energy dissipation and pollution transfer, and is gradually being applied in the treatment of high ammonia-nitrogen wastewater. However, the anammox process still has problems such as substandard total nitrogen (TN) and residual NO₃⁻—N. For NO₃⁻—N, coupled heterotrophic denitrification is often used for the purpose of deep denitrification, which leads to the increase in carbon source input cost and surplus sludge yield, resulting in a new problem of excessive organic matter. Considering the high carbon source demand and high treatment cost of denitrification for high-nitrogen wastewater, research has been conducted in recent years on autotrophic denitrification using inorganic substances as electron donors. By replacing organic carbon source with low-valence sulfur, synchronous autotrophic denitrification and heterotrophic denitrification have been achieved, while denitrification and carbon source saving effects are enhanced. For example, a pyrrhotite-based autotrophic denitrification biofilter was established to treat secondary effluent from a wastewater treatment plant, which effectively removes N and P from the wastewater lacking organic matter simultaneously. Sodium thiosulfate was combined with pyrite to achieve rapid, economical, and efficient denitrification of low-C/N actual wastewater. Low-valence iron can also be used as an electron donor for autotrophic or heterotrophic denitrification. For example, acclimated iron-based autotrophic denitrifying bacteria were used as a bacterial source to establish an upflow reactor to treat secondary effluent. After 30 days of operation, chemical oxygen demand (COD) and TN in the effluent were effectively removed. Compared with sulfur-based or iron-based autotrophic denitrification processes, the sulfur and iron coupled denitrification process has more advantages. The sulfur-based autotrophic denitrification process yields acids, and the iron-based autotrophic denitrification process yields alkalis. The sulfur and iron synergistic autotrophic or heterotrophic denitrification can balance pH to reduce corresponding drawbacks and reduce emissions of N₂O and other greenhouse gases.

The low sludge yield and slow growth rate in the autotrophic biological treatment process limit the active biomass concentration in the reaction system, affecting its adaptability to various environmental factors and causing potential operational instability. Therefore, the development of a bioreactor with a high active biomass concentration and stable ecology has aroused people's great interest. However, the prior art still needs improvement.

### SUMMARY

In view of the aforementioned shortcomings in the prior art, an objective of the present disclosure is to provide a method and device for treating coking wastewater through denitrification and anammox. The present disclosure solves the problems that the existing biochemical treatment method for coking wastewater requires a large amount of carbon source but cannot meet the effluent discharge standard.

The present disclosure adopts the following technical solutions.

A device for treating coking wastewater through denitrification and anammox includes an anaerobic reactor, an anoxic reactor, a sedimentation tank, and an aerobic reactor that are sequentially communicated through pipes, a coking wastewater tank communicated with the anaerobic reactor through an influent pump, and an aeration pump communicated with the aerobic reactor, where the coking wastewater tank is connected to a S₂O₃²⁻ tank above through a pipe; the anaerobic reactor includes a side provided with a first drainage valve and a bottom provided with a first sludge valve; the anoxic reactor is connected to a first powder carrier tank above through a pipe, and includes a side provided with a second drainage valve and a bottom provided with a second sludge valve; the sedimentation tank includes a bottom provided with a sludge outlet and an internal space provided with an overflow weir; the sludge outlet is communicated with the anaerobic reactor through a sludge reflux pump; the aerobic reactor is connected to a second powder carrier tank, an inorganic carbon source tank, and an effluent pump above through pipes, and includes a side provided with a third drainage valve and a bottom provided with a third sludge valve; and the aerobic reactor is communicated with the anoxic reactor through a nitrification solution reflux pump.

In the device for treating coking wastewater through denitrification and anammox, the pipe connecting the coking wastewater tank and the S₂O₃²⁻ tank is provided with a first flow control valve; and the S₂O₃²⁻ tank is configured to provide a sulfur source.

In the device for treating coking wastewater through denitrification and anammox, the anaerobic reactor is provided therein with a first agitator; the anoxic reactor is provided therein with a second agitator; and the pipe connecting the anoxic reactor and the first powder carrier tank is provided with a second flow control valve.

In the device for treating coking wastewater through denitrification and anammox, a pipe connecting the aeration pump and the aerobic reactor is provided with a rotameter and connected to an aeration bar; and the aeration bar is located at an inner bottom of the aerobic reactor.

In the device for treating coking wastewater through denitrification and anammox, the pipe connecting the aerobic reactor and the second powder carrier tank is provided with a third flow control valve; and the pipe connecting the aerobic reactor and the inorganic carbon source tank is provided with a fourth flow control valve.

A method for treating coking wastewater through denitrification and anammox, based on the device for treating coking wastewater through denitrification and anammox, includes the following steps:

inoculating cultured anammox activated sludge and flocculent sludge from a coking wastewater biochemical treatment system into the anaerobic reactor and the anoxic reactor, and inoculating the flocculent sludge from the coking wastewater biochemical treatment system into the aerobic reactor;

controlling, by the aeration pump, dissolved oxygen (DO) to 3.0-4.0 mg/L in the aerobic reactor, below 0.5 mg/L in the anoxic reactor, and below 0.2 mg/L in the anaerobic reactor;

adjusting, by the inorganic carbon source tank, pH to 7.5-8.0 in the aerobic reactor, 7.0-7.5 in the anoxic reactor, and 7.0-7.5 in the anaerobic reactor;

starting the influent pump, and adjusting an inflow rate such that a hydraulic retention time (HRT) of the entire device is 80-100 h; and setting a water temperature to 30-35° C., a nitrification solution reflux ratio to 300-400%, and a sludge reflux ratio to 100-120%;

starring testing and debugging after the device gradually stabilizes; adjusting the inflow rate such that the HRT of the entire device is 60-80 h; adjusting a dosage of S₂O₃²⁻ such that a sulfur/nitrogen (S/N) molar ratio in the coking wastewater in the coking wastewater tank is 0.8-1.0; adjusting, by the first powder carrier tank, dosages of diatomaceous earth powder, polyaluminium chloride (PAC), and pyrite powder added into the anoxic reactor to 150-200 mg/L, 5-10 mg/L, and 120-150 mg/L, respectively; adjusting, by the second powder carrier tank, dosages of the diatomaceous earth powder and the PAC added into the aerobic reactor to 150-200 mg/L and 5-10 mg/L, respectively; and avoiding sludge discharge during a debugging stage of the device, and controlling a concentration of a mixed solution in the device to gradually reach a target of 10-12 g/L;

completing device startup when sludge flocs in the device gradually decreases, a smooth biofilm is formed on a surface of a powder carrier and microgranular sludge is formed, and an effluent presents less than 20 mg/L of total nitrogen (TN) and less than 5 mg/L of NH₄⁺—N; and

controlling, after device startup is completed, the S₂O₃²⁻ tank to gradually reduce the dosage of S₂O₃²⁻ into the coking wastewater tank until S₂O₃²⁻ is no longer added; calculating and adjusting, when microbial enrichment is formed on the surface of the powder carrier, a supplementation amount and a proportional distribution of the powder carrier according to a sludge discharge amount and a reactant demand.

In the method for treating coking wastewater through denitrification and anammox, the calculating and adjusting a supplementation amount and a proportional distribution of the powder carrier according to a sludge discharge amount and a reactant demand includes: adjusting, by the first powder carrier tank, the dosages of the diatomaceous earth powder, the PAC, and the pyrite powder added into the anoxic reactor to 10-30 mg/L, 1-2 mg/L, and 100-150 mg/L, respectively; and adjusting, by the second powder carrier tank, the dosages of the diatomaceous earth powder and the PAC added into the aerobic reactor to 30-50 mg/L and 2-5 ml/L, respectively.

The present disclosure has the following beneficial effects. Compared with the prior art, the present disclosure uses S₂O₃²⁻ and pyrite powder as electron donors to acclimate sulfur-based autotrophic denitrifying bacteria. S₂O₃²⁻ can be well utilized by microorganisms, and the low-concentration S₂O₃²⁻ does not have toxic effects on microorganisms. Pyrite is an abundant and low-price environmentally friendly material. The sulfur and iron-based autotrophic or heterotrophic denitrification can balance acidity and alkalinity and maintain high denitrification efficiency and system stability. The powder carrier promotes the symbiosis of suspended and attached sludge, forming granular sludge to enhance biological treatment efficiency, improve sludge characteristics, and enhance sedimentation and dewatering performance, facilitating sludge treatment. The anaerobic/anoxic reaction section and the aerobic reaction section form the dual-sludge system through the sedimentation tank. The design prevents anammox bacteria and autotrophic denitrifying bacteria from being affected by external environmental fluctuations (such as pH and DO), reduces the oxidation of the powdered pyrite in the aerobic reactor to avoid sulfur resource waste, and reduces the inhibitory effect of the powdered pyrite on the denitrifying bacteria, thereby maintaining efficient and stable denitrification performance. This system achieves the goal of treating without the need for additional organic carbon sources, avoiding the demand for a large amount of carbon sources in traditional biochemical processes. Autotrophic denitrification significantly reduces N₂O emissions and provides an economically green biological denitrification method.

### BRIEF DESCRIPTION OF THE DRAWINGS

FIG. 1 is a structural diagram of a device for treating coking wastewater through denitrification and anammox according to the present disclosure; and

FIG. 2 is a schematic diagram showing a test operation mode and parameter setting of a method for treating coking wastewater through denitrification and anammox according to the present disclosure.

### DETAILED DESCRIPTION OF THE EMBODIMENTS

The present disclosure provides a device and method for treating coking wastewater through denitrification and anammox. To make the objectives, technical solutions, and effects of the present disclosure clearer, the following further describes the present disclosure in detail. It should be understood that the specific embodiments described herein are merely intended to explain the present disclosure, but not to limit the present disclosure.

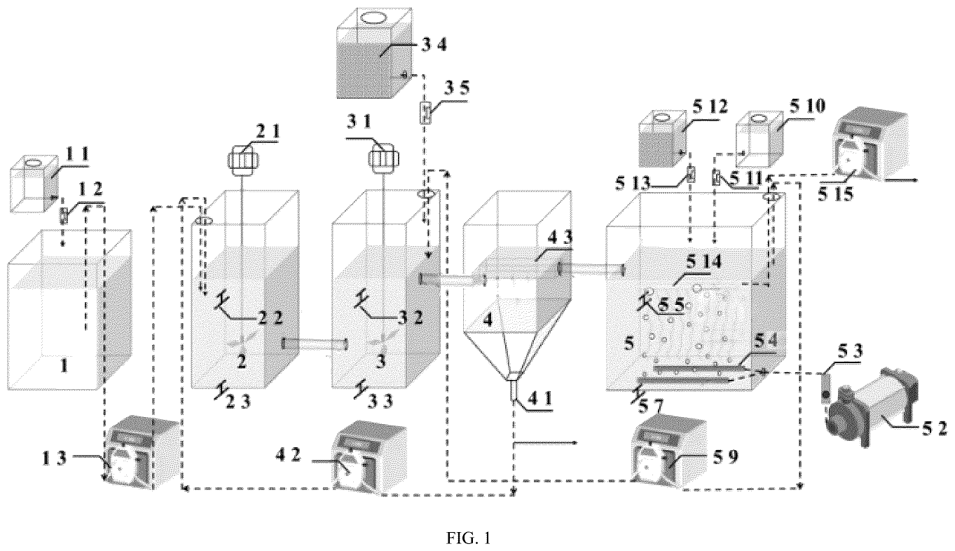

FIG. 1 is a schematic diagram of a device for treating coking wastewater through denitrification and anammox according to the present disclosure. As shown in FIG. 1, the device includes anaerobic reactor 2, anoxic reactor 3, sedimentation tank 4, and aerobic reactor 5 that are sequentially communicated through pipes, coking wastewater tank 1 communicated with the anaerobic reactor 2 through influent pump 13, and aeration pump 52 communicated with the aerobic reactor 5. The coking wastewater tank 1 is connected to S₂O₃²⁻ tank 11 above through a pipe. The anaerobic reactor 2 includes a side provided with first drainage valve 22 and a bottom provided with first sludge valve 23. The anoxic reactor 3 is connected to first powder carrier tank 34 above through a pipe. The anoxic reactor includes a side provided with second drainage valve 32 and a bottom provided with second sludge valve 33. The sedimentation tank 4 includes a bottom provided with sludge outlet 41 and an internal space provided with overflow weir 43. The sludge outlet 41 is communicated with the anaerobic reactor 2 through sludge reflux pump 42. The aerobic reactor 5 is connected to second powder carrier tank 512, inorganic carbon source tank 510, and effluent pump 515 above through pipes. The aerobic reactor 5 includes a side provided with third drainage valve 55 and a bottom provided with third sludge valve 57. The aerobic reactor 5 is communicated with the anoxic reactor 3 through nitrification solution reflux pump 59.

In the present disclosure, the pipe connecting the coking wastewater tank 1 and the S₂O₃²⁻ tank 11 is provided with first flow control valve 12. The S₂O₃²⁻ tank 11 is configured to provide a sulfur source. The anaerobic reactor 2 is provided therein with first agitator 21. The anoxic reactor 3 is provided therein with second agitator 31. The pipe connecting the anoxic reactor 3 and the first powder carrier tank 34 is provided with second flow control valve 35. A pipe connecting the aeration pump 52 and the aerobic reactor 5 is provided with rotameter 53. The pipe connecting the aeration pump 52 is connected to aeration bar 54. The aeration bar 54 is located at an inner bottom of the aerobic reactor 5. The pipe connecting the aerobic reactor 5 and the second powder carrier tank 512 is provided with third flow control valve 513. The pipe connecting the aerobic reactor 5 and the inorganic carbon source tank 510 is provided with fourth flow control valve 511. The aerobic reactor 5 is provided with membrane component 514. The membrane component is connected to the effluent pump 515 to discharge water.

In the present disclosure, the first agitator 21 in the anaerobic reactor 2 is configured to keep a sludge-water mixture uniformly mixed. The first powder carrier tank 34 connected to the anoxic reactor is configured to feed a powder carrier through the first flow control valve 35. The second agitator 31 in the anaerobic reactor is configured to keep the sludge-water mixture uniformity mixed. The sludge outlet 41 is connected to the anaerobic reactor 2 through a sludge reflux pipe, with a connection provided with the sludge reflux pump 42. The sedimentation tank is provided with the overflow weir 43 for tailwater discharge. The aerobic reactor 5 is connected to the sedimentation tank 4 through a water hose. Nitrification solution reflux pipe and nitrification solution reflux pump 59 are provided between the aerobic reactor 5 and the anoxic reactor 3. Air in an aerobic zone enters the aerobic reactor sequentially through the aeration pump 52, the rotameter 53, and the aeration bar 54 to maintain dissolved oxygen (DO) required for biochemical treatment and maintain the uniformity of the sludge-water mixture, thereby achieving pollutant removal and nitrification functions. The aerobic reactor 5 is provided with the inorganic carbon source tank 510 and the third powder carrier tank 512 that are configured to provide a powder carrier and an inorganic carbon source respectively through flow control valves. The aerobic reactor 5 is provided therein with the membrane component 514 that is connected to the effluent pump 515 to discharge water.

Specifically, sludge granulation is an advanced environmental biotechnology that provides feasible strategies for accumulating activity and increasing biomass. Compared with coagulated sludge, granular sludge has rich microbial diversity, high biomass concentration, high sludge settleability, and dense structure. It usually has high adaptability to high-strength wastewater and shock loads. Diatomaceous earth has a density similar to water, so it can be well distributed in wastewater without settling or floating. In addition, diatomaceous earth has high biocompatibility and rich porosity, making it easy for microorganisms to adhere. To solve the problems that the biochemical treatment of coking wastewater requires a large amount of carbon source and cannot meet the effluent discharge standard, the present disclosure proposes a method and device for treating coking wastewater through synchronous heterotrophic and autotrophic denitrification and anammox. The present disclosure uses a combination of diatomaceous earth and pyrite powder as a carrier to promote sludge granulation and form microgranular sludge, and promote the anammox and autotrophic denitrification processes. The present disclosure can treat high-nitrogen wastewater without the need for an external carbon source, thereby achieving efficient denitrification and significantly reducing operating costs and carbon footprint.

In the present disclosure, the coking wastewater undergoes ammonia distillation and dephenolization processes in advance and is then pumped into the anaerobic reactor. The complex chain cyclic compounds in the high-concentration ammonia distillation wastewater are hydrolyzed and opened in the anaerobic section to become simple cyclic compounds for subsequent biochemical reactions. The use of the composite powder carrier increases the microbial biomass of the reaction unit, while the use of the sulfur source promotes the generation of intermediate product NO⁻—N from autotrophic denitrification and promotes anammox in the anaerobic reactor. The anoxic reactor uses influent organic matter, the powder carrier pyrite, and influent thiocyanide as electron donors, and uses the nitrification solution returned from the aerobic reactor as an electron acceptor for denitrification under the action of facultative bacteria and autotrophic bacteria. The sedimentation tank forms a dual-sludge system to reduce reducing inorganic sulfur-containing substances that enter into the aerobic reactor to compete with the denitrifying bacteria. Nitrification reactions mainly occur in the aerobic reactor. In addition, some ionic reducing inorganic sulfur-containing substances that not fully utilized in the anoxic reactor enter the aerobic reactor along with the flowing water and are oxidized into sulfates.

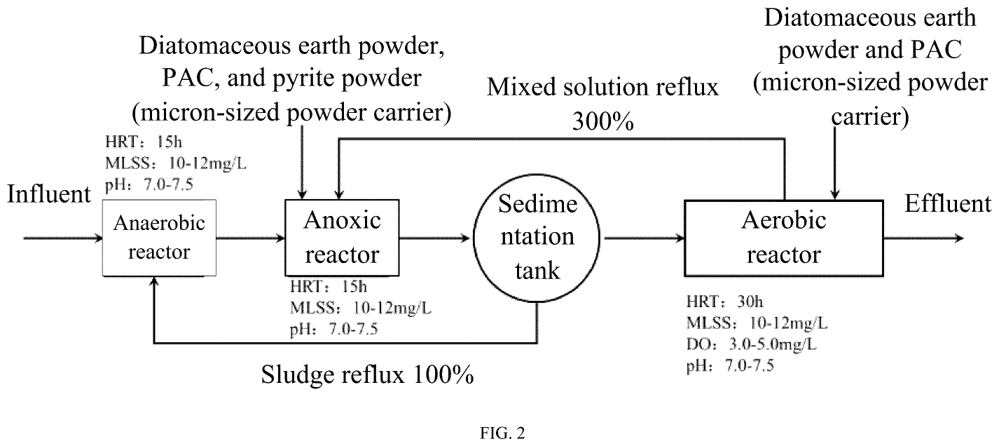

In some implementations, the present disclosure further provides a method for treating coking wastewater through denitrification and anammox based on the device for treating coking wastewater through denitrification and anammox. As shown in FIG. 2, the method includes the following steps.

Device startup is carried out as follows.

The device shown in FIG. 1 is communicated. Cultured partial nitrification and anammox (PN/A) activated sludge and flocculent sludge from a coking wastewater biochemical treatment system are inoculated into the anaerobic reactor and the anoxic reactor, and the flocculent sludge from the coking wastewater biochemical treatment system is inoculated into the aerobic reactor. The mixed liquor suspended solids (MLSS) concentration in the flocculent sludge is controlled to 3,000-4,000 mg/L. The actual coking wastewater inflow includes: COD=1,200-3,000 mg/L, NH₄⁺—N=100-150 mg/L, NO₃⁻—N=80-100 mg/L, and SCN⁻=170-180 mg/L. The volume ratio of the anaerobic reactor, the anoxic reactor, and the aerobic reactor is 1:1:2. The aeration of the aerobic reactor and the agitators of the anaerobic reactor and the anoxic reactor are adjusted. Through the rotameter, the DO in the aerobic reactor is controlled to 3.0-4.0 mg/L, the DO in the anoxic reactor is controlled to below 0.5 mg/L, and the DO in the anaerobic reactor is controlled to below 0.2 mg/L. Through the inorganic carbon source (mainly sodium carbonate solution) tank, the pH in the aerobic reactor is controlled to 7.5-8.0, the pH in the anoxic reactor is controlled to 7.0-7.5, and the pH in the anaerobic reactor is controlled to 7.0-7.5. The water is continuously fed into the device. The inflow rate is controlled such that a hydraulic retention time (HRT) of the entire system is 80-100 h. The operating parameters of the device are as follows: water temperature 30-35° C., nitrification solution reflux ratio 300-400%, and sludge reflux ratio 100-120%;

After the device gradually stabilizes, testing and debugging are carried out with a solution of low dosage and gradually increasing concentration of the mixture. The inflow rate is controlled such that the HRT of the entire device is 60-80 h. To improve the denitrification performance of the device, sodium thiosulfate, pyrite powder and organic matter are combined to acclimate a mixed bacterial system of the anaerobic reactor and the anoxic reactor. The coking wastewater is blended with the material added by the S₂O₃²⁻ tank above the coking wastewater tank. The characteristic pollutant SCN⁻ in the coking wastewater serves as a sulfur source to provide electrons participating in autotrophic denitrification. By regulating the dosage of S₂O₃²⁻, the S/N molar ratio in the coking wastewater in the coking wastewater tank is controlled to 0.8-1.0. Meanwhile, the dosage of the powder carrier-diatomaceous earth powder, PAC, and pyrite powder in the anoxic reactor is 150-200 mg/L, 5-10 mg/L, and 120-150 mg/L, respectively. In the aerobic reactor, the dosage of the powder carrier-diatomaceous earth powder and the PAC is 150-200 mg/L and 5-10 mg/L, respectively. The powder carrier has a micron size. During the debugging stage of the device, no sludge discharge is carried out, and the concentration of the mixed solution in the device gradually reaches the target of 10-12 g/L. The device startup is completed when the sludge flocs in the device gradually decrease, a smooth biofilm is formed on the surface of the powder carrier and microgranular sludge is formed, and the TN concentration in the effluent is less than 20 mg/L and the NH4-N concentration in the effluent is less than 5mg/L,.

Device operation is carried out as follows.

The S₂O₃²⁻ tank is controlled to gradually reduce the amount of S₂O₃²⁻ added into the coking wastewater tank until it is no longer added. When microbial enrichment is formed on the surface of the powder carrier, the changes in the concentration of the mixed solution and the mixed liquor volatile suspended solids (MLVSS) ratio (MLVS/MLSS maintained at 0.27-0.33) are detected, and the supplementation amount of the powder carrier is determined. The ratio of the composite powder is calculated and adjusted based on the sludge discharge amount and reactant demand to maintain the concentration of the mixed solution in the reactor and maintain stable treatment efficiency. In the anaerobic reactor, the complex chain cyclic compounds in the high-concentration ammonia distillation wastewater are hydrolyzed and opened in the anaerobic section to become simple cyclic compounds for subsequent biochemical reactions. The use of the composite powder carrier increases the microbial biomass of the reaction unit, while the use of the pyrite powder promotes the sulfur-based autotrophic denitrification of the system. The autotrophic denitrification using FeS₂+SCN⁻ as the sulfur source produces intermediate product NO₂⁻—N, promoting anammox in the anaerobic reactor. The HRT of the anaerobic reactor is 15-20 h, and the pH in the anaerobic reactor is maintained at 7.0-7.5. In the anoxic zone, the organic matter in the influent is used as the carbon source and energy source, the pyrite in the powder carrier and the thiocyanide in the influent are used as the sulfur source, and the nitrification solution returned from the aerobic reactor is used as the nitrogen source for denitrification. The reflux ratio of the nitration solution is 300-400%. In this way, denitrification is carried out under the synergistic effect of facultative bacteria and autotrophic bacteria. The HRT of the anoxic reactor is 15-20 h, and the pH in the anoxic reactor is maintained at 7.0-7.5. In the outflow of the anaerobic reactor, the concentration of NO₃⁻—N is less than 5 mg/L, the concentration of NH4—N is 20-40 mg/L, and the concentration of NO₂⁻—N is less than 1 mg/L. The outflow from the anoxic reactor enters the sedimentation tank for sedimentation, and the sludge returns the anaerobic reactor to form a dual-sludge system, with a sludge reflux ratio of 100-120%. The outflow from the sedimentation tank enters the aerobic reactor. Nitrification reactions mainly occur in this reaction stage. In addition, some unoxidized reducing inorganic sulfur-containing substances enter the aerobic reactor with the water flow and are oxidized into sulfates. The HRT of the aerobic reactor is 30-40 h, the pH in the aerobic reactor is maintained at 7.5-7.0, and the DO is maintained at 3.0-5.0 mg/L. In the outflow of the aerobic reactor, the concentration of NH₄⁺—N is less than 5 mg/L, the concentration of TN is less than 20 mg/L, and the concentration of NO₂⁻—N is less than 0.2 mg/L. The coking wastewater is treated by the anaerobic reactor, the anoxic reactor, the sedimentation tank, and the aerobic reactor, and is finally discharged through the membrane component.

The present disclosure reduces the impact of sulfur-based autotrophic denitrification on aerobic nitrification and the oxidation of the pyrite powder carrier through the dual-sludge system, maintaining stable operation of the coupled system of heterotrophic-autotrophic denitrification and anammox. The present disclosure promotes the symbiosis of suspended and attached sludge through the powder carrier, increases the concentration of system microorganisms, and provides a sulfur source to promote the autotrophic denitrification process. In addition, the present disclosure provides multiple electron donors through the high-concentration composite powder carrier and promotes sludge granulation, ensuring stable and efficient denitrification of the system.

In summary, the present disclosure uses S₂O₃²⁻ and pyrite powder as electron donors to acclimate sulfur-based autotrophic denitrifying bacteria. S₂O₃²⁻ can be well utilized by microorganisms, and the low-concentration S₂O₃²⁻ does not have toxic effects on microorganisms. Pyrite is an abundant and low-price environmentally friendly material. The sulfur and iron-based autotrophic or heterotrophic denitrification can balance acidity and alkalinity and maintain high denitrification efficiency and system stability. The powder carrier promotes the symbiosis of suspended and attached sludge, forming granular sludge to enhance biological treatment efficiency, improve sludge characteristics, and enhance sedimentation and dewatering performance, facilitating sludge treatment. The anaerobic/anoxic reaction section and the aerobic reaction section form the dual-sludge system through the sedimentation tank. The design prevents anammox bacteria and autotrophic denitrifying bacteria from being affected by external environmental fluctuations (such as pH and DO), reduces the oxidation of the powdered pyrite in the aerobic reactor to avoid sulfur resource waste, and reduces the inhibitory effect of the powdered pyrite on the denitrifying bacteria, thereby maintaining efficient and stable denitrification performance. This system achieves the goal of treating without the need for additional organic carbon sources, avoiding the demand for a large amount of carbon sources in traditional biochemical processes. Autotrophic denitrification significantly reduces N₂O emissions and provides an economically green biological denitrification method.

It should be understood that the present disclosure is not limited to the above examples. Therefore, those of ordinary skill in the art can make improvements or transformations based on the above description, and all these improvements and transformations should fall within the protection scope of the appended claims of the present disclosure.

What is claimed is:

1. A device for treating coking wastewater through denitrification and anammox, comprising an anaerobic reactor, an anoxic reactor, a sedimentation tank, an aerobic reactor, a coking wastewater tank communicated with the anaerobic reactor through an influent pump, and an aeration pump communicated with the aerobic reactor; wherein the anaerobic reactor, the anoxic reactor, the sedimentation tank, and the aerobic reactor are sequentially communicated through first pipes, the coking wastewater tank is connected to a S₂O₃²⁻ tank above through a second pipe;
the anaerobic reactor comprises a side provided with a first drainage valve and a bottom provided with a first sludge valve; the anoxic reactor is connected to a first powder carrier tank above through a third pipe, and the anoxic reactor comprises a side provided with a second drainage valve and a bottom provided with a second sludge valve; the sedimentation tank comprises a bottom provided with a sludge outlet and an internal space provided with an overflow weir; the sludge outlet is communicated with the anaerobic reactor through a sludge reflux pump; the aerobic reactor is connected to a second powder carrier tank, an inorganic carbon source tank, and an effluent pump above through fourth pipes, and the aerobic reactor comprises a side provided with a third drainage valve and a bottom provided with a third sludge valve; and the aerobic reactor is communicated with the anoxic reactor through a nitrification solution reflux pump.

2. The device for treating the coking wastewater through the denitrification and anammox according to claim 1, wherein the second pipe connecting the coking wastewater tank and the S₂O₃²⁻ tank is provided with a first flow control valve; and the S₂O₃²⁻ tank is configured to provide a sulfur source.

3. The device for treating the coking wastewater through the denitrification and anammox according to claim 1, wherein the anaerobic reactor is provided therein with a first agitator; the anoxic reactor is provided therein with a second agitator; and the third pipe connecting the anoxic reactor and the first powder carrier tank is provided with a second flow control valve.

4. The device for treating the coking wastewater through the denitrification and anammox according to claim 1, wherein a fifth pipe connecting the aeration pump and the aerobic reactor is provided with a rotameter and connected to an aeration bar; and the aeration bar is located at an inner bottom of the aerobic reactor.

5. The device for treating the coking wastewater through the denitrification and anammox according to claim 1, wherein the fourth pipes connecting the aerobic reactor and the second powder carrier tank is provided with a third flow control valve; and the fourth pipes connecting the aerobic reactor and the inorganic carbon source tank is provided with a fourth flow control valve.

6. A method for treating coking wastewater through denitrification and anammox, based on the device for treating the coking wastewater through the denitrification and anammox according to claim 1, and comprising the following steps:
inoculating a cultured anammox activated sludge and a flocculent sludge from a coking wastewater biochemical treatment system into the anaerobic reactor and the anoxic reactor, and inoculating the flocculent sludge from the coking wastewater biochemical treatment system into the aerobic reactor;
controlling, by the aeration pump, dissolved oxygen (DO) to 3.0-4.0 mg/L in the aerobic reactor, below 0.5 mg/L in the anoxic reactor, and below 0.2 mg/L in the anaerobic reactor;
adjusting, by the inorganic carbon source tank, pH to 7.5-8.0 in the aerobic reactor, 7.0-7.5 in the anoxic reactor, and 7.0-7.5 in the anaerobic reactor;
starting the influent pump, and adjusting an inflow rate such that a hydraulic retention time (HRT) of the device is 80-100 h; and setting a water temperature to 30-35° C., a nitrification solution reflux ratio to 300-400%, and a sludge reflux ratio to 100-120%;
starring testing and debugging after the device gradually stabilizes; adjusting the inflow rate such that the HRT of the device is 60-80 h; adjusting a dosage of S₂O₃²⁻ such that a sulfur/nitrogen (S/N) molar ratio in the coking wastewater in the coking wastewater tank is 0.8-1.0; adjusting, by the first powder carrier tank, dosages of diatomaceous earth powder, polyaluminium chloride (PAC), and pyrite powder added into the anoxic reactor to 150-200mg/L, 5-10 mg/L, and 120-150 mg/L, respectively; adjusting, by the second powder carrier tank, dosages of diatomaceous earth powder and PAC added into the aerobic reactor to 150-200 mg/L and 5-10 mg/L, respectively; and avoiding sludge discharge during a debugging stage of the device, and controlling a concentration of a mixed solution in the device to gradually reach a target of 10-12 g/L;
completing device startup when sludge flocs in the device gradually decreases, a smooth biofilm is formed on a surface of a powder carrier and a microgranular sludge is formed, and an effluent presents less than 20 mg/L of total nitrogen (TN) and less than 5 mg/L of NH₄⁺—N; and
controlling, after the device startup is completed, the S₂O₃²⁻ tank to gradually reduce the dosage of the S₂O₃²⁻ into the coking wastewater tank until the S₂O₃²⁻ is no longer added; calculating and adjusting, when microbial enrichment is formed on the surface of the powder carrier, a supplementation amount and a proportional distribution of the powder carrier according to a sludge discharge amount and a reactant demand.

7. The method for treating the coking wastewater through the denitrification and anammox according to claim 6, wherein the calculating and adjusting the supplementation amount and the proportional distribution of the powder carrier according to the sludge discharge amount and the reactant demand comprises: adjusting, by the first powder carrier tank, the dosages of the diatomaceous earth powder, the PAC, and the pyrite powder added into the anoxic reactor to 10-30 mg/L, 1-2 mg/L, and 100-150 mg/L, respectively; and adjusting, by the second powder carrier tank, the dosages of the diatomaceous earth powder and the PAC added into the aerobic reactor to 30-50 mg/L and 2-5 ml/L, respectively.

8. A method for treating coking wastewater through denitrification and anammox, based on the device for treating the coking wastewater through the denitrification and anammox according to claim 2, and comprising the following steps:
inoculating a cultured anammox activated sludge and a flocculent sludge from a coking wastewater biochemical treatment system into the anaerobic reactor and the anoxic reactor, and inoculating the flocculent sludge from the coking wastewater biochemical treatment system into the aerobic reactor;
controlling, by the aeration pump, dissolved oxygen (DO) to 3.0-4.0 mg/L in the aerobic reactor, below 0.5 mg/L in the anoxic reactor, and below 0.2 mg/L in the anaerobic reactor;
adjusting, by the inorganic carbon source tank, pH to 7.5-8.0 in the aerobic reactor, 7.0-7.5 in the anoxic reactor, and 7.0-7.5 in the anaerobic reactor;
starting the influent pump, and adjusting an inflow rate such that a hydraulic retention time (HRT) of the device is 80-100 h; and setting a water temperature to 30-35° C., a nitrification solution reflux ratio to 300-400%, and a sludge reflux ratio to 100-120%;
starring testing and debugging after the device gradually stabilizes; adjusting the inflow rate such that the HRT of the device is 60-80 h; adjusting a dosage of S₂O₃²⁻ such that a sulfur/nitrogen (S/N) molar ratio in the coking wastewater in the coking wastewater tank is 0.8-1.0; adjusting, by the first powder carrier tank, dosages of diatomaceous earth powder, polyaluminium chloride (PAC), and pyrite powder added into the anoxic reactor to 150-200mg/L, 5-10 mg/L, and 120-150 mg/L, respectively; adjusting, by the second powder carrier tank, dosages of diatomaceous earth powder and PAC added into the aerobic reactor to 150-200 mg/L and 5-10 mg/L, respectively; and avoiding sludge discharge during a debugging stage of the device, and controlling a concentration of a mixed solution in the device to gradually reach a target of 10-12 g/L;
completing device startup when sludge flocs in the device gradually decreases, a smooth biofilm is formed on a surface of a powder carrier and a microgranular sludge is formed, and an effluent presents less than 20 mg/L of total nitrogen (TN) and less than 5 mg/L of NH₄⁺—N; and
controlling, after the device startup is completed, the S₂O₃²⁻ tank to gradually reduce the dosage of the S₂O₃²⁻ into the coking wastewater tank until the S₂O₃²⁻ is no longer added;
calculating and adjusting, when microbial enrichment is formed on the surface of the powder carrier, a supplementation amount and a proportional distribution of the powder carrier according to a sludge discharge amount and a reactant demand.

9. A method for treating coking wastewater through denitrification and anammox, based on the device for treating the coking wastewater through the denitrification and anammox according to claim 3, and comprising the following steps:
inoculating a cultured anammox activated sludge and a flocculent sludge from a coking wastewater biochemical treatment system into the anaerobic reactor and the anoxic reactor, and inoculating the flocculent sludge from the coking wastewater biochemical treatment system into the aerobic reactor;
controlling, by the aeration pump, dissolved oxygen (DO) to 3.0-4.0 mg/L in the aerobic reactor, below 0.5 mg/L in the anoxic reactor, and below 0.2 mg/L in the anaerobic reactor;
adjusting, by the inorganic carbon source tank, pH to 7.5-8.0 in the aerobic reactor, 7.0-7.5 in the anoxic reactor, and 7.0-7.5 in the anaerobic reactor;
starting the influent pump, and adjusting an inflow rate such that a hydraulic retention time (HRT) of the device is 80-100 h; and setting a water temperature to 30-35° C., a nitrification solution reflux ratio to 300-400%, and a sludge reflux ratio to 100-120%;
starring testing and debugging after the device gradually stabilizes; adjusting the inflow rate such that the HRT of the device is 60-80 h; adjusting a dosage of S₂O₃²⁻ such that a sulfur/nitrogen (S/N) molar ratio in the coking wastewater in the coking wastewater tank is 0.8-1.0; adjusting, by the first powder carrier tank, dosages of diatomaceous earth powder, polyaluminium chloride (PAC), and pyrite powder added into the anoxic reactor to 150-200mg/L, 5-10 mg/L, and 120-150 mg/L, respectively; adjusting, by the second powder carrier tank, dosages of diatomaceous earth powder and PAC added into the aerobic reactor to 150-200 mg/L and 5-10 mg/L, respectively; and avoiding sludge discharge during a debugging stage of the device, and controlling a concentration of a mixed solution in the device to gradually reach a target of 10-12 g/L;
completing device startup when sludge flocs in the device gradually decreases, a smooth biofilm is formed on a surface of a powder carrier and a microgranular sludge is formed, and an effluent presents less than 20 mg/L of total nitrogen (TN) and less than 5 mg/L of NH₄⁺—N; and
controlling, after the device startup is completed, the S₂O₃²⁻ tank to gradually reduce the dosage of the S₂O₃²⁻ into the coking wastewater tank until the S₂O₃²⁻ is no longer added; calculating and adjusting, when microbial enrichment is formed on the surface of the powder carrier, a supplementation amount and a proportional distribution of the powder carrier according to a sludge discharge amount and a reactant demand.

10. A method for treating coking wastewater through denitrification and anammox, based on the device for treating the coking wastewater through the denitrification and anammox according to claim 4, and comprising the following steps:
inoculating a cultured anammox activated sludge and a flocculent sludge from a coking wastewater biochemical treatment system into the anaerobic reactor and the anoxic reactor, and inoculating the flocculent sludge from the coking wastewater biochemical treatment system into the aerobic reactor;
controlling, by the aeration pump, dissolved oxygen (DO) to 3.0-4.0 mg/L in the aerobic reactor, below 0.5 mg/L in the anoxic reactor, and below 0.2 mg/L in the anaerobic reactor;
adjusting, by the inorganic carbon source tank, pH to 7.5-8.0 in the aerobic reactor, 7.0-7.5 in the anoxic reactor, and 7.0-7.5 in the anaerobic reactor;
starting the influent pump, and adjusting an inflow rate such that a hydraulic retention time (HRT) of the device is 80-100 h; and setting a water temperature to 30-35° C., a nitrification solution reflux ratio to 300-400%, and a sludge reflux ratio to 100-120%;
starring testing and debugging after the device gradually stabilizes; adjusting the inflow rate such that the HRT of the device is 60-80 h; adjusting a dosage of S₂O₃²⁻ such that a sulfur/nitrogen (S/N) molar ratio in the coking wastewater in the coking wastewater tank is 0.8-1.0; adjusting, by the first powder carrier tank, dosages of diatomaceous earth powder, polyaluminium chloride (PAC), and pyrite powder added into the anoxic reactor to 150-200mg/L, 5-10 mg/L, and 120-150 mg/L, respectively; adjusting, by the second powder carrier tank, dosages of diatomaceous earth powder and PAC added into the aerobic reactor to 150-200 mg/L and 5-10 mg/L, respectively; and avoiding sludge discharge during a debugging stage of the device, and controlling a concentration of a mixed solution in the device to gradually reach a target of 10-12 g/L;
completing device startup when sludge flocs in the device gradually decreases, a smooth biofilm is formed on a surface of a powder carrier and a microgranular sludge is formed, and an effluent presents less than 20 mg/L of total nitrogen (TN) and less than 5 mg/L of NH₄⁺—N; and
controlling, after the device startup is completed, the S₂O₃²⁻ tank to gradually reduce the dosage of the S₂O₃²⁻ into the coking wastewater tank until the S₂O₃²⁻ is no longer added; calculating and adjusting, when microbial enrichment is formed on the surface of the powder carrier, a supplementation amount and a proportional distribution of the powder carrier according to a sludge discharge amount and a reactant demand.

11. A method for treating coking wastewater through denitrification and anammox, based on the device for treating the coking wastewater through the denitrification and anammox according to claim 5, and comprising the following steps:
inoculating a cultured anammox activated sludge and a flocculent sludge from a coking wastewater biochemical treatment system into the anaerobic reactor and the anoxic reactor, and inoculating the flocculent sludge from the coking wastewater biochemical treatment system into the aerobic reactor;
controlling, by the aeration pump, dissolved oxygen (DO) to 3.0-4.0 mg/L in the aerobic reactor, below 0.5 mg/L in the anoxic reactor, and below 0.2 mg/L in the anaerobic reactor;
adjusting, by the inorganic carbon source tank, pH to 7.5-8.0 in the aerobic reactor, 7.0-7.5 in the anoxic reactor, and 7.0-7.5 in the anaerobic reactor;
starting the influent pump, and adjusting an inflow rate such that a hydraulic retention time (HRT) of the device is 80-100 h; and setting a water temperature to 30-35° C., a nitrification solution reflux ratio to 300-400%, and a sludge reflux ratio to 100-120%;
starring testing and debugging after the device gradually stabilizes; adjusting the inflow rate such that the HRT of the device is 60-80 h; adjusting a dosage of S₂O₃²⁻ such that a sulfur/nitrogen (S/N) molar ratio in the coking wastewater in the coking wastewater tank is 0.8-1.0; adjusting, by the first powder carrier tank, dosages of diatomaceous earth powder, polyaluminium chloride (PAC), and pyrite powder added into the anoxic reactor to 150-200mg/L, 5-10 mg/L, and 120-150 mg/L, respectively; adjusting, by the second powder carrier tank, dosages of diatomaceous earth powder and PAC added into the aerobic reactor to 150-200 mg/L and 5-10 mg/L, respectively; and avoiding sludge discharge during a debugging stage of the device, and controlling a concentration of a mixed solution in the device to gradually reach a target of 10-12 g/L;
completing device startup when sludge flocs in the device gradually decreases, a smooth biofilm is formed on a surface of a powder carrier and a microgranular sludge is formed, and an effluent presents less than 20 mg/L of total nitrogen (TN) and less than 5 mg/L of NH₄⁺—N; and
controlling, after the device startup is completed, the S₂O₃²⁻ tank to gradually reduce the dosage of the S₂O₃²⁻ into the coking wastewater tank until the S₂O₃²⁻ is no longer added; calculating and adjusting, when microbial enrichment is formed on the surface of the powder carrier, a supplementation amount and a proportional distribution of the powder carrier according to a sludge discharge amount and a reactant demand.

12. The method for treating the coking wastewater through the denitrification and anammox according to claim 8, wherein the calculating and adjusting the supplementation amount and the proportional distribution of the powder carrier according to the sludge discharge amount and the reactant demand comprises: adjusting, by the first powder carrier tank, the dosages of the diatomaceous earth powder, the PAC, and the pyrite powder added into the anoxic reactor to 10-30 mg/L, 1-2 mg/L, and 100-150 mg/L, respectively; and adjusting, by the second powder carrier tank, the dosages of the diatomaceous earth powder and the PAC added into the aerobic reactor to 30-50 mg/L and 2-5 ml/L, respectively.

13. The method for treating the coking wastewater through the denitrification and anammox according to claim 9, wherein the calculating and adjusting the supplementation amount and the proportional distribution of the powder carrier according to the sludge discharge amount and the reactant demand comprises: adjusting, by the first powder carrier tank, the dosages of the diatomaceous earth powder, the PAC, and the pyrite powder added into the anoxic reactor to 10-30 mg/L, 1-2 mg/L, and 100-150 mg/L, respectively; and adjusting, by the second powder carrier tank, the dosages of the diatomaceous earth powder and the PAC added into the aerobic reactor to 30-50 mg/L and 2-5 ml/L, respectively.

14. The method for treating the coking wastewater through the denitrification and anammox according to claim 10, wherein the calculating and adjusting the supplementation amount and the proportional distribution of the powder carrier according to the sludge discharge amount and the reactant demand comprises: adjusting, by the first powder carrier tank, the dosages of the diatomaceous earth powder, the PAC, and the pyrite powder added into the anoxic reactor to 10-30 mg/L, 1-2 mg/L, and 100-150 mg/L, respectively; and adjusting, by the second powder carrier tank, the dosages of the diatomaceous earth powder and the PAC added into the aerobic reactor to 30-50 mg/L and 2-5 ml/L, respectively.

15. The method for treating the coking wastewater through the denitrification and anammox according to claim 11, wherein the calculating and adjusting the supplementation amount and the proportional distribution of the powder carrier according to the sludge discharge amount and the reactant demand comprises: adjusting, by the first powder carrier tank, the dosages of the diatomaceous earth powder, the PAC, and the pyrite powder added into the anoxic reactor to 10-30 mg/L, 1-2 mg/L, and 100-150 mg/L, respectively; and adjusting, by the second powder carrier tank, the dosages of the diatomaceous earth powder and the PAC added into the aerobic reactor to 30-50 mg/L and 2-5 ml/L, respectively.
